(19) United States
(12) Patent Application Publication
(10) Pub. No.: US 2025/0021144 A1
(43) Pub. Date: Jan. 16, 2025

(54) COOLING A COMPUTING DEVICE

(71) Applicant: Microsoft Technology Licensing, LLC, Redmond, WA (US)

(72) Inventors: Chien Lung YANG, Sammamish, WA (US); Todd Alan CHILES, Redmond, WA (US); Yin XIONG, Sammamish, WA (US)

(73) Assignee: Microsoft Technology Licensing, LLC, Redmond, WA (US)

(21) Appl. No.: 18/713,386

(22) PCT Filed: Oct. 27, 2022
(86) PCT No.: PCT/US2022/078769

§ 371 Date: May 24, 2024

(30) Foreign Application Priority Data
Dec. 2, 2021 (NL) 2029996

(51) Int. Cl. G06F 1/20; G06F 1/16

(52) U.S. Cl. CPC G06F 1/206; G06F 1/1616; G06F 1/1656; G06F 1/1677; G06F 1/203; G06F 2200/1633

(57) ABSTRACT

A computing device comprises a cover, a chassis, a cover closure sensor, and a cooling fan. An airflow detector and a thermal sensor are located within the chassis. The computing device comprises a processor and a memory storing instructions executable by the processor to detect a thermal trip condition using at least signals from the airflow detector, the thermal sensor, and the cover closure sensor. A cooling action is performed at least on condition of (1) determining that a velocity of an airflow within at least a portion of the chassis is less than or equal to a threshold velocity, (2) determining that the cover is closed, and (3) determining that a temperature of the computing device is greater than or equal to a threshold temperature.

### BACKGROUND

Electronic systems may produce excess heat during operation. For example, a computing device includes various components that generate heat during operation, such as processors, memory devices, and display devices. A cooling system may be used to thermally regulate such an electronic system during operation.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

Examples are disclosed that relate to computing devices and methods for performing a cooling action in a computing device. In one example, a computing device comprises a cover and a chassis. The computing device further comprises a cover closure sensor configured to indicate whether the cover is closed over the chassis. A cooling fan inside the chassis is configured to generate an airflow within at least a portion of the chassis. The computing device further comprises an airflow detector located within the chassis and a thermal sensor located within the chassis. In addition, the computing device comprises a processor and a memory storing instructions executable by the processor to detect a thermal trip condition using at least signals from the airflow detector, the thermal sensor, and the cover closure sensor. The instructions are executable to determine, using the airflow detector, a velocity of the airflow. The cover closure sensor is used to determine that the cover is closed. A temperature of the computing device is determined using the thermal sensor. The instructions are further executable to, at least on condition of (1) determining that the velocity of the airflow is less than or equal to a threshold velocity, (2) determining that the cover is closed, and (3) determining that the temperature of the computing device is greater than or equal to a threshold temperature, perform a cooling action.

### BRIEF DESCRIPTION OF THE DRAWINGS

FIG. 1 shows an example of a computing device in the form of a laptop computing device according to examples of the present disclosure.

FIG. 2 shows another example of a computing device according to examples of the present disclosure.

FIG. 3 shows one example of a cooling fan and an airflow sensor that may be used in the computing device of FIG. 1 or the computing device of FIG. 2 according to examples of the present disclosure.

FIG. 4 shows a partial cross-sectional view of the exhaust opening of the cooling fan and the airflow sensor of FIG. 3 according to examples of the present disclosure.

FIG. 5 shows another example of an airflow detector that may be used in the computing device of FIG. 1 or the computing device of FIG. 2 according to examples of the present disclosure.

FIG. 6 shows a schematic diagram of an electrical circuit that can be used as the airflow detector of FIGS. 3-5 according to examples of the present disclosure.

FIG. 7 shows a plot of electrical current in the electrical circuit of FIG. 6 as a function of air velocity according to examples of the present disclosure.

FIG. 8 shows a block diagram of an example method for performing a cooling action according to examples of the present disclosure.

FIG. 9 shows a block diagram of an example computing system according to examples of the present disclosure.

### DETAILED DESCRIPTION

Electronic systems may produce excess heat during operation. For example, a computing device includes various components that generate heat during operation, such as processors, memory devices, and display devices. If not mitigated, excess heat generated by such components can impair device performance and/or cause device failure. Accordingly, a cooling system may be used to thermally regulate such an electronic system during operation. Operation of the cooling system may be controlled using the output of thermal sensors within the electronic system.

However, some portions of an electronic device may have different temperatures than other portions of the device. For example, when a laptop computing device is placed into a protective sleeve while remaining operational, a surface temperature of a portion of the laptop (e.g., at a cover or a palmrest of the laptop) may surpass an internal temperature of the device (e.g., a central processing unit (CPU) temperature). In these examples, triggering operation of a cooling system when the internal temperature reaches a threshold temperature may not prevent excursions of the surface temperature above the threshold.

To prevent the surface temperature from exceeding the threshold or other predetermined temperature, the internal temperature threshold to trigger the cooling system may be lowered. However, triggering a cooling action (e.g., throttling a processor or placing the device into a standby mode) at a lower internal temperature can impair device performance and adversely affect a user's experience. In addition, it can be challenging to accurately track the surface temperature of a device, as fluctuations in ambient environmental conditions and errors due to sensor placement can lead to uncertainty in surface temperature measurements.

Accordingly, and as described in more detail below, examples are disclosed that relate to detecting a thermal trip condition using at least signals from an airflow detector located within a chassis of a computing device, a thermal sensor located within the chassis, and a cover closure sensor. A cooling action is performed at least on condition of (1) determining that a velocity of an airflow within at least a portion of the chassis is less than or equal to a threshold velocity, (2) determining that a cover of the device is closed, and (3) determining that a temperature of the computing device is greater than or equal to a threshold temperature. In this manner, the temperature of the computing device can be regulated in a highly precise and accurate manner, including in situations where the effectiveness of a cooling device such as a fan is impaired, such as when the computing device is placed into a protective sleeve. In addition, the thermal trip condition can be detected without sensing fan speed and/or operation, thereby conserving computing resources and preventing performance impairment and/or device failure if fan speed and/or operation data is incorrect.

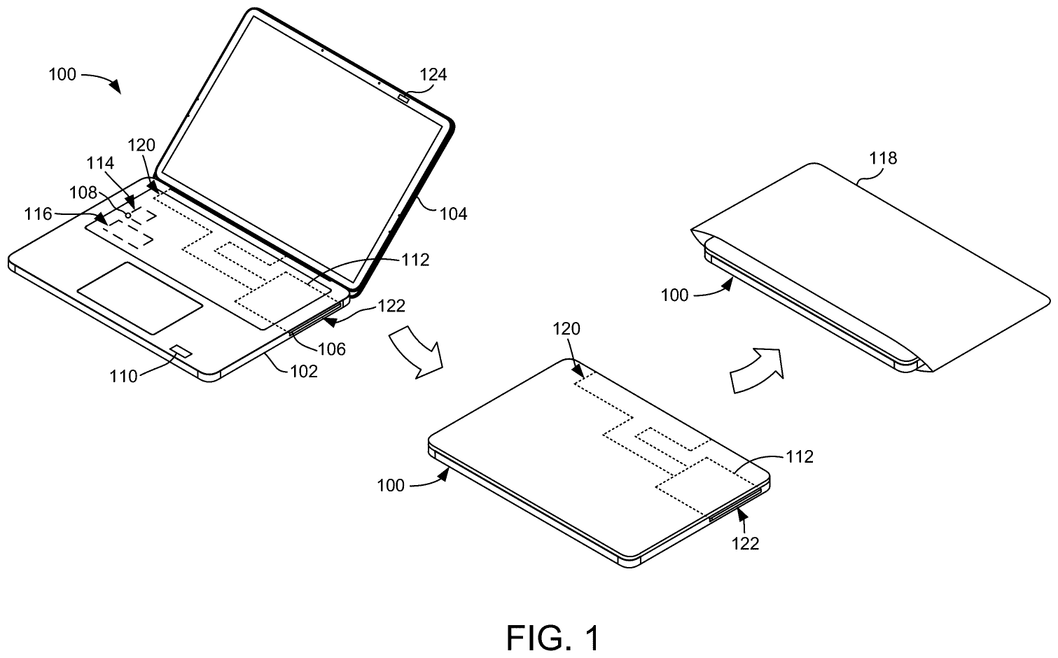

FIG. 1 shows one example of a computing device comprising a cover and a chassis. In the example of FIG. 1, the computing device is a laptop computing device 100. The computing device 100 comprises a base chassis 102 that is rotatably coupled to a cover comprising a display chassis 104. In various examples, (e.g., in a two-in-one computing device), the display chassis 104 and the base chassis 102 may be detachable.

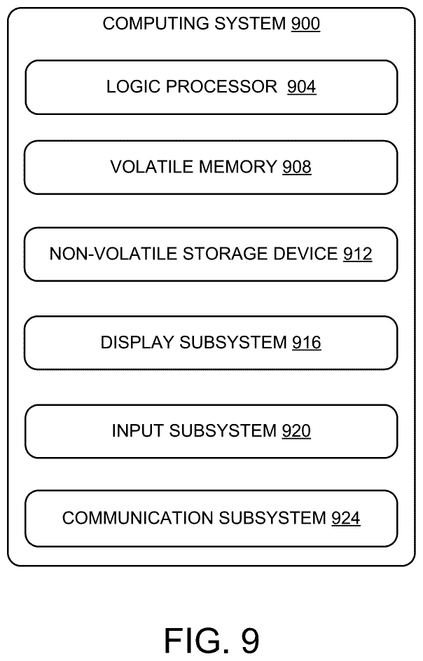

Briefly, the laptop computing device 100 comprises an airflow detector 106 located within the base chassis 102, a thermal sensor 108 located within the base chassis 102, and a display closure sensor 110 configured to indicate whether the display chassis 104 is closed over the base chassis 102. A cooling fan 112 is located inside the base chassis 102, and is configured to generate an airflow within at least a portion of the base chassis. The computing device 100 further comprises a processor 114 and a memory 116 storing instructions executable by the processor 114 to detect a thermal trip condition using at least signals from the airflow detector 106, the thermal sensor 108, and the display closure sensor 110. Additional aspects of the laptop computing device 100 are described in more detail below with reference to FIG. 9.

It will also be appreciated that any other suitable type of computing device may be used. Other suitable examples of computing devices include tablet computing devices, server computing devices, home-entertainment computers, network computing devices, gaming devices, mobile computing devices, and mobile communication devices (e.g., a smart phone).

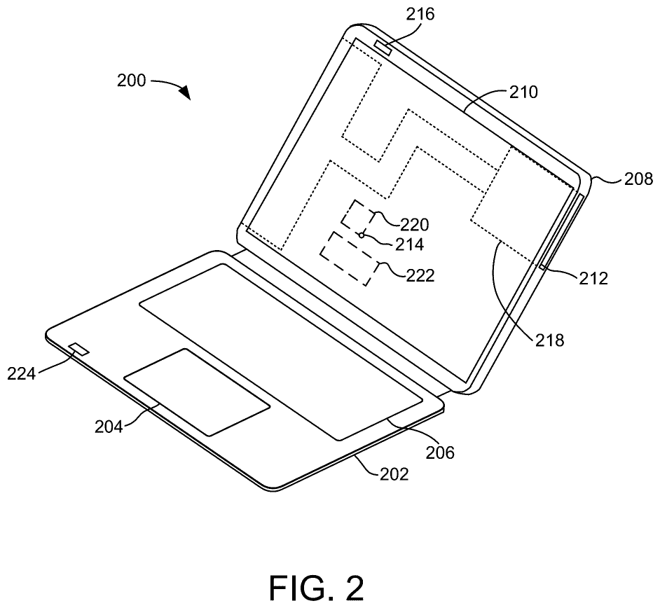

FIG. 2 shows another example of a suitable computing device in the form of a tablet computing device 200. The tablet computing device 200 comprises a cover 202 that includes a trackpad 204 and a keyboard 206. The tablet computing device 200 further comprises a chassis 208 that houses a display subsystem 210 of the device. In various examples, the cover 202 may be detachable from the chassis 208.

The tablet computing device 200 includes an airflow detector 212, a thermal sensor 214, a cover closure sensor 216 configured to indicate whether the cover 202 is closed over the chassis 208, a cooling fan 218, a processor 220, and a memory 222 storing instructions executable by the processor 220. Like the laptop computing device 100 of FIG. 1, the tablet computing device 200 is configured to detect a thermal trip condition using at least signals from the airflow detector 212, the thermal sensor 214, and the cover closure sensor 216. However, in this example the airflow detector 212, thermal sensor 214, cover closure sensor 216, cooling fan 218, and computing hardware are housed within a unitary chassis 208 along with the display subsystem 210. Housing the airflow detector 212, thermal sensor 214, cover closure sensor 216, cooling fan 218, and computing hardware within the chassis can protect these components (e.g., against damage). Additional aspects of the tablet computing device 200 are described in more detail below with reference to FIG. 9.

With reference again to FIG. 1, in some use case examples the laptop computing device 100 may be placed into a closed or airflow-restricted environment, such as a protective sleeve, backpack, or other container that blocks or limits airflow to and from the device. In the example shown in FIG. 1, when the computing device 100 is inserted into the protective sleeve 118, an intake vent 120 and an exhaust vent 122 of the device are covered by the sleeve, which thereby obstructs airflow from the surrounding environment through the device. Obstruction of the intake vent 120 and/or the exhaust vent 122 reduces a velocity of the airflow through the device, thereby impairing the ability of the fan 112 to cool the device. Additionally, any remaining airflow may simply serve to recirculate heated exhaust from the exhaust vent 122 within the sleeve 118, further impairing device cooling. In other use cases a variety of other conditions and/or placements of the computing device 100 can similarly obstruct airflow through the device. Examples include a closed device sliding between cushions of a sofa and a blanket or towel covering the intake vent 120 and/or exhaust vent 122.

Accordingly, and in one potential advantage of the present disclosure, a thermal trip condition may be detected that triggers performance of a cooling action using at least signals from the airflow detector, the thermal sensor, and the cover closure sensor of the device. For example, the methods and devices disclosed herein may be employed to perform a cooling action that can mitigate the thermal effects of placing a computing device into a case.

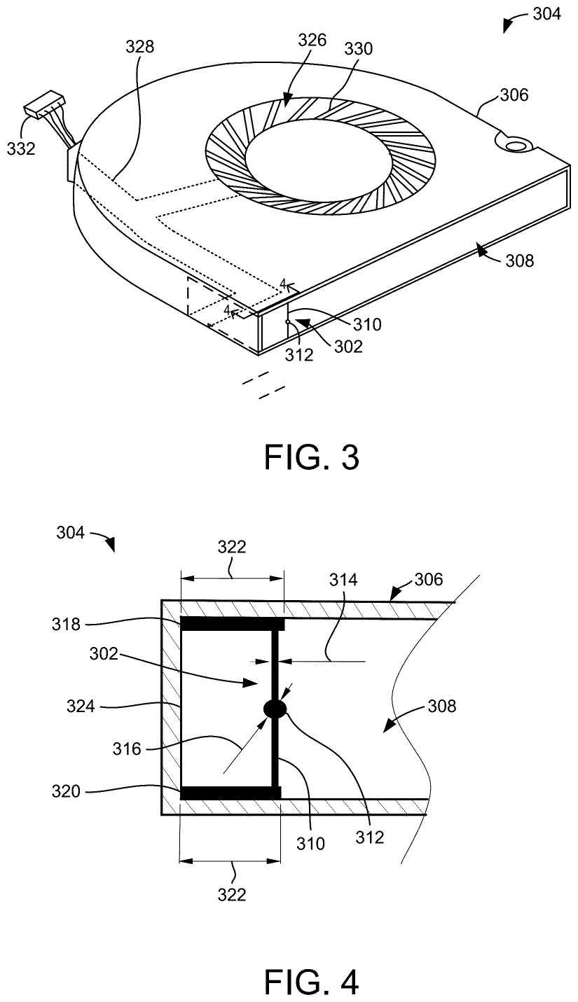

As described in more detail below, the airflow detector is used to determine a velocity of the airflow within at least a portion of the chassis. FIG. 3 shows one example of an airflow detector 302 that may be used in the computing device of FIG. 1 or the computing device of FIG. 2. For example, the airflow detector 302 can serve as the airflow detector 106 of FIG. 1 or the airflow detector 212 of FIG. 2.

In the example of FIG. 3, the airflow detector 302 is located within a cooling fan assembly 304. The cooling fan assembly 304 can serve as the cooling fan 112 of FIG. 1 or the cooling fan 218 of FIG. 2. The cooling fan assembly 304 comprises a housing 306 and an exhaust opening 308 in the housing 306. In this example the airflow detector 302 is located within the exhaust opening 308. In this manner, the airflow detector 302 may be used to measure the airflow propelled out of the cooling fan assembly 304 and quantify any air exchange between the interior and exterior of a device. In this example the airflow detector 302 comprises a lead wire 310 stretched across the exhaust opening 308. The lead wire 310 may comprise a high-strength conductive material, such as tungsten, platinum alloy or copper. As described in more detail below, the lead wire 310 can function as a hot wire anemometer to determine the velocity of the airflow through the exhaust opening 308. The airflow detector 302 also includes a thermistor bead 312 located on the wire 310. The thermistor 312 can be used to measure the temperature of the airflow propelled out of the exhaust opening 308 by the fan.

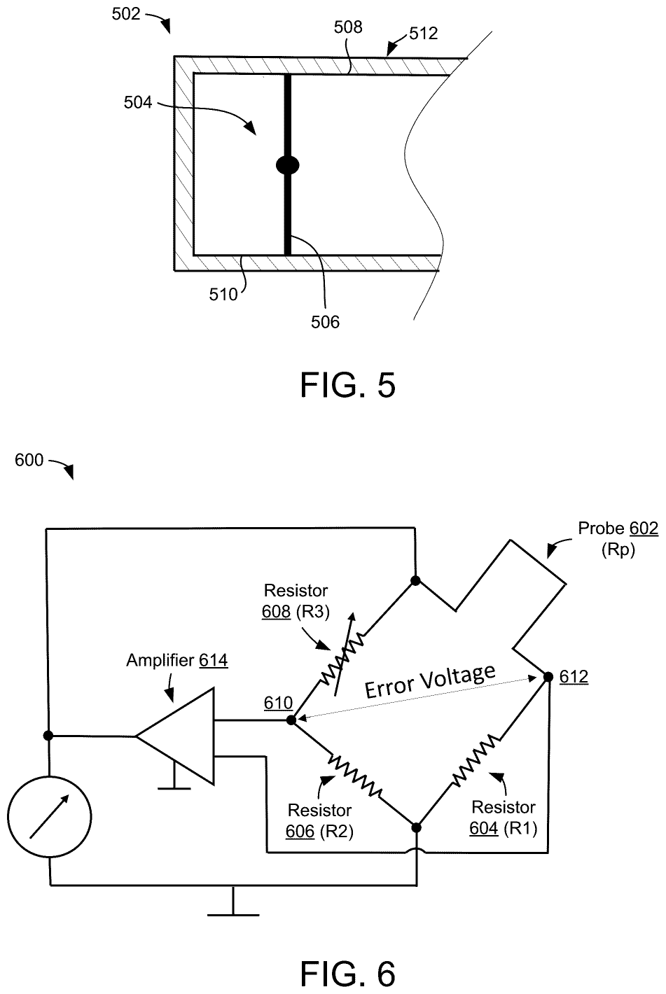

FIG. 4 shows a partial cross-sectional view of a portion of the cooling fan assembly 304 and the airflow detector 302 taken along line 4-4 of FIG. 3. In the example of FIG. 4, the airflow detector 302 is suspended between a top support beam 318 and a bottom support beam 320. More particularly, the lead wire 310 is stretched between and attached to the top support beam 318 and a bottom support beam 320. In some examples, the lead wire/support beam assembly is easily inserted into an existing housing structure of a cooling fan without additional structural modification. Further, in some examples the support beams may insulate the lead wire from the rest of the cooling fan assembly. In other examples, the cooling fan assembly and the airflow detector may not include support beams. For example, FIG. 5 shows a partial cross-sectional view of a portion of another example of a cooling fan assembly 502 and an airflow detector 504 that may be used in the computing device of FIG. 1 or the computing device of FIG. 2. In this example, a lead wire 506 of the airflow detector 504 is coupled directly to a top wall 508 and a bottom wall 510 of a housing 512 for the cooling fan assembly 502. In some examples, the airflow detector 504 can serve as the airflow detector 106 of FIG. 1 or the airflow detector 212 of FIG. 2, and the cooling fan assembly 502 can serve as the cooling fan 112 of FIG. 1 or the cooling fan 218 of FIG. 2. Providing the lead wire 506 without support beams reduces the structural complexity of the airflow detector 504 relative to the airflow detector 302 of FIGS. 3-4.

With reference again to the example of FIGS. 3-4, in some examples the lead wire 310 may have a diameter 314 in the range of 0.03 mm to 0.08 mm. In the example of FIG. 4, the diameter 314 of the lead wire 310 is 0.05 mm. In this manner, the lead wire may not increase system impedance or substantially obstruct the airflow. It will also be appreciated that the lead wire 310 may have any other suitable dimensions.

The thermistor 312 may comprise a spherical bead having a diameter 316 in the range of 0.08 mm to 0.2 mm. In the example of FIG. 4, the diameter 316 of the thermistor 312 is 0.10 mm. In this manner, the thermistor may not increase system impedance or substantially obstruct the airflow. It will also be appreciated that the thermistor 312 may have any other suitable dimensions.

The cooling fan assembly 304 may further comprise a gap 322 between the lead wire 310 of airflow detector 302 and a side wall 324 of the housing 306. In some examples, the gap 322 is greater than or equal to 0.5 mm. In this manner, the airflow detector 302 is spaced at least 0.5 mm from the side wall 324. In the example of FIG. 4, the gap 322 is 0.5 mm. In this manner, the airflow detector 302 may be able to accurately measure the velocity of the airflow through the exhaust opening 308 without being influenced by turbulence or other aerodynamic effects that may occur at the side wall 324. It will also be appreciated that the airflow detector 302 may be positioned at any other suitable location across the width of the exhaust opening 308.

In other examples and with reference to FIG. 3, the airflow detector 302 may be located within an intake opening 326 of the housing 306, or along an airflow path between the intake opening 326 and the exhaust opening 308. In other examples, the airflow detector 302 may be located outside of the housing 306 of the fan assembly 304. For example, and with reference again to FIG. 1, the airflow detector 106 may be located at the exhaust vent 122, the intake vent 120, or between the intake vent 120 and the exhaust vent 122 of the laptop 100. Providing the airflow detector at any of these locations allows the device to obtain an accurate measurement of the airflow at that location (e.g., the airflow entering the device at the intake vent, or traversing a heat sink within the device).

FIG. 6 shows a schematic diagram of one example of an electrical circuit 600 comprising a Wheatstone bridge that can be used as an airflow sensor. In some examples the electrical circuit 600 can be utilized with the airflow detector 106 of FIG. 1, the airflow detector 212 of FIG. 2, the airflow detector 302 of FIGS. 3-4, or the airflow detector 504 of FIG. 5.

An electrical current is sent to a probe 602 which is placed in an airflow. In the examples of FIGS. 3-4 and FIG. 5, the lead wire 310 and lead wire 506, respectively, can serve as the probe 602. As the current is sent to the probe 602 the temperature of the probe 602 rises. When air flows over the probe 602, the probe 602 is cooled down.

The circuit 600 uses a first resistor 604 and a second resistor 606 having known, fixed resistances R1 and R2, respectively, and a variable resistor 608 having a variable resistance R3 that may be utilized to determine the velocity of the airflow. The probe 602 of the airflow detector serves as another resistor having a resistance Rp that is a function of the probe's temperature. The circuit is balanced when R1/Rp=R2/R3. When it is balanced, there is no voltage error between points 610 and 612 shown in FIG. 6.

Initially, the resistance R3 of the variable resistor 608 can be adjusted to balance the circuit 600 under a given probe temperature. Air flowing over the probe 602 causes the temperature and resistance Rp of the probe to change. This causes the circuit to become unbalanced, with a voltage difference between points 610 and 612. When this voltage difference is detected by an amplifier 614, the amplifier adjusts the current feedback to rebalance the circuit, and thus the probe temperature is kept constant, along with the probe resistance Rp. The changes in the current are measured, and the airflow velocity over the probe 602 can be calculated.

In some examples, the airflow velocity over the probe 602 can be calculated via the following equations. As represented in equation 1 below, when the probe 602 is put in an airflow and the probe is heated by a power input, the power input is equal to the power lost to heat transfer through convection:

$$\\ \begin{matrix}{I}^{{}_{} 2} {R}_{p} = {hA}_{p} ( {T}_{p} - {T}_{a} ) & ( 1 )\end{matrix}$$

Here, Rₚ represents the resistance of the probe 602, Tₚ represents the temperature of the probe 602, Tₐ represents the air temperature, Aₚ represents the probe surface area, and h is a heat convection coefficient.

Rₚ can be expressed in the form of equation 2 as a function of temperature.

$$\\ \begin{matrix}{R}_{p} = {R}_{Ref} [ 1 + θ ( {T}_{p} - {T}_{Ref} ) ] & ( 2 )\end{matrix}$$

Here, θ is a thermal coefficient of resistance, and R_{Ref} represents the resistance at a reference temperature, T_{Ref}.

The heat convection coefficient (h) can be expressed in the form of equation 3 as a function of air velocity (vₐ).

$$\\ \begin{matrix}h = x + {yv}_{a}^{{}_{} z} & ( 3 )\end{matrix}$$

In equation 3, x, y, and z are calibration coefficients. In one example, the coefficient z may have a value of approximately 0.5.

Combining equations 1-3 gives equation 4.

$$\\ \begin{matrix}x + {yv}_{a}^{{}_{} z} = \frac{{I}^{{}_{} 2} {R}_{p}}{{A}_{p} ( {T}_{p} - {T}_{a} )} = \frac{{I}^{{}_{} 2} {R}_{Ref} [ 1 + θ ( {T}_{p} - {T}_{Ref} ) ]}{{A}_{p} ( {T}_{p} - {T}_{a} )} & ( 4 )\end{matrix}$$

Accordingly, the air velocity (vₐ) may be expressed in the form of equation 5.

$$\\ \begin{matrix}{v}_{a} = \sqrt[{{z}_{}}_{}]{\{ \frac{{I}^{{}_{} 2} {R}_{Ref} [ 1 + θ ( {T}_{p} - {T}_{Ref} ) ]}{{A}_{p} ( {T}_{p} - {T}_{a} )} - x \} / y} & ( 5 )\end{matrix}$$

Given the probe 602 is powered by an adjustable current to maintain a constant temperature, equation 5 can be simplified as described by equation 6.

$$\\ \begin{matrix}{v}_{a} = f ( I , {T}_{a} ) & ( 6 )\end{matrix}$$

As described in equation 4, I² is a function of h when keeping Tₚ constant. Accordingly, I² can be described as below in equation 7.

$$\\ \begin{matrix}{I}^{{}_{} 2} = {x}^{{}_{} ′} + {y}^{{}_{} ′} {v}_{a}^{{}_{} z} & ( 7 )\end{matrix}$$

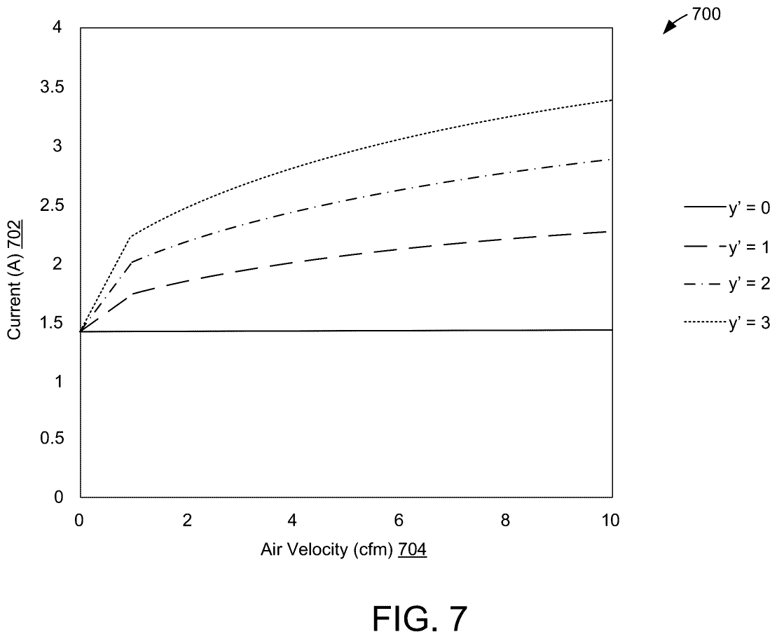

Here, x′ is a zero point which can be offset via calibration, and y′ is the ambient related sensitivity (ambient temperature) which can be determined through a thermistor on the probe. FIG. 7 shows a plot 700 of electrical current 702 as a function of air velocity 704 for various sensitivity/temperature (y′) values.

As introduced above, one or more components included in the electrical circuit 600 of FIG. 6 may be housed in a cooling fan assembly. For example, the resistors 604, 606, and 608 and the amplifier 614 may be integrated within a flexible printed circuit (FPC), such as FPC 328 of FIG. 3, which is configured to electrically couple cooling fan 330 and airflow detector 302 to a computing device, such as laptop 100, via connector 332. Accordingly, and in one potential advantage of the present disclosure, signals from the airflow detector 302 may be routed to the processor or other suitable computing hardware of the computing device without additional cables and connectors.

In some examples, when the airflow velocity measured by the airflow detector is less than or equal to a threshold velocity, a thermal trip condition can be indicated. For example, and as described above, the airflow velocity within at least a portion of the laptop computing device 100 of FIG. 1 can drop below the threshold velocity when the laptop computing device 100 is inside the protective sleeve 118. In some examples, the threshold velocity is in the range of 0 meters/second (m/s) to 0.01 m/s. In other examples, the threshold velocity is in the range of 0 m/s to 0.02 m/s. It will also be appreciated that the threshold velocity may comprise any other suitable velocity. For example, in a device having a high-power fan (e.g., a 70 cfm fan), the threshold velocity may be 0.1 m/s or higher.

Additionally, a thermal trip condition can be indicated by determining that the cover of the computing device is closed over the chassis. In some examples and as noted above with reference to FIGS. 1 and 2, a cover closure sensor can be utilized to determine that the cover is closed. For example, the cover closure sensor 110 of FIG. 1 and the cover closure sensor 216 of FIG. 2 may each take the form of a Hall effect sensor. In FIG. 1 the Hall effect sensor of cover closure sensor 110 detects a magnetic field from a magnet 124 located on the display chassis 104 to indicate that the display chassis 104 of the laptop 100 is closed over the base chassis 102. In FIG. 2 the Hall effect sensor of cover closure sensor 216 detects a magnetic field from a magnet 224 located on the cover 202 of FIG. 2 to indicate that the cover 202 is closed over the chassis 208 of FIG. 2.

In other examples, cover closure sensors may comprise any other suitable type of sensor, such as an optical sensor or a mechanical switch that is actuated when the cover is closed. In some examples, determining that the cover is closed may indicate that the computing device is not being actively used by the user, and that escalating heat within the device could continue for an extended period of time. Accordingly, and in another potential advantage of the present disclosure, this condition also can be utilized to trigger a thermal trip condition.

A thermal trip condition also can be indicated by determining that the temperature of the computing device is greater than or equal to a threshold temperature In some examples, one or more physical thermal sensors, such as thermistors, may be utilized. For example, the thermal sensor 108 of FIG. 1 and/or the thermal sensor 214 of FIG. 2 may each comprise a CPU thermal sensor integrated within the processor 114 or the processor 220, respectively. In other examples, the thermal sensor may comprise a virtual thermal sensor that determines and outputs a temperature value for a location on or inside the computing device based upon one or more physical sensors at one or more other locations on or inside the computing device. In this manner, the virtual thermal sensor provides temperature information without incorporating additional physical temperature sensors into the device. The virtual thermal sensor may also provide useful temperature information at a location that may be difficult to access with a physical sensor.

In some examples, a threshold temperature is in the range of 34° C. to 62° C. The threshold temperature in the range of 34° C. to 62° C. protects components of the computing device from thermal damage. It will also be appreciated that the threshold temperature may comprise any other suitable temperature. In examples where two or more thermal sensors are utilized in a computing device, the threshold temperature may be the same or different for each thermal sensor. In different examples and configurations of computing devices, different threshold temperatures can be utilized based on the location being measured in or within the computing device, one or more physical properties of materials used in the computing device, one or more cooling actions available to the computing device, and/or other considerations. For example, a computing device fabricated from heat-tolerant materials and configured to operate in hot conditions (e.g., in ambient temperatures above 32° C.) may have a threshold temperature greater than 62° C.

As noted above, and in one potential advantage of the present disclosure, at least on condition of (1) determining that the velocity of the airflow is less than or equal to a threshold velocity, (2) determining that the cover is closed, and (3) determining that the temperature of the computing device is greater than or equal to a threshold temperature, a cooling action is performed to reduce heat accumulation within the computing device. Advantageously, by determining the existence of at least these three conditions, configurations of the present disclosure can regulate the temperature of the computing device in a precise and accurate manner, including in situations where the effectiveness of a cooling device is impaired, such as when the computing device is placed into a protective sleeve. In addition, the thermal trip condition can be detected without sensing fan speed and/or operation, thereby conserving computing resources and preventing performance impairment and/or device failure if fan speed and/or operation data is incorrect. Further, by utilizing at least these three conditions to trigger performance of a cooling action, a higher threshold temperature may be utilized as compared to using just a threshold temperature to trigger cooling actions. In this manner, higher operating temperatures of the device may be utilized, thereby providing longer active operation of the computing device before reaching the threshold temperature and potentially throttling device performance.

As noted, in some examples the cooling action comprises throttling performance of the computing device. For example, the cooling action may comprise throttling a processor speed to reduce heat generated by the processor. Additionally or alternatively, in some examples the cooling action comprises placing the computing device into a low-power standby mode in which one or more processes and/or hardware components are throttled or paused, or a lower-power hibernate mode in which additional processes and/or hardware components are throttled or paused, to reduce heat generated by these processes and/or components. In yet other examples, the cooling action comprises shutting down the computing device.

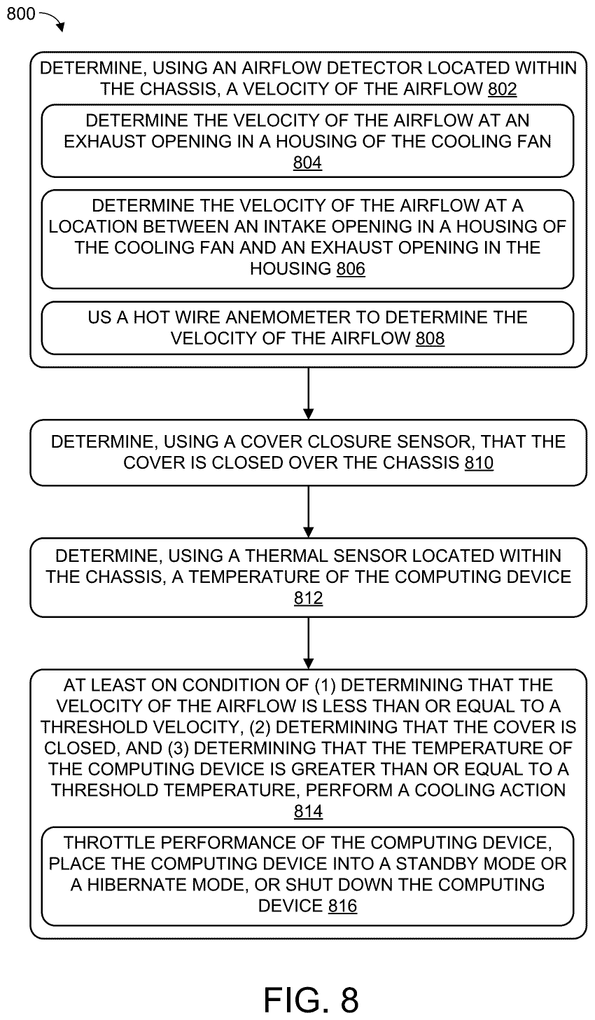

FIG. 8 illustrates, at a computing device comprising a cover, a chassis, and a cooling fan configured to generate an airflow within at least a portion of the chassis, an example method 800 for performing a cooling action. The following description of method 800 is provided with reference to the components described herein and shown in FIGS. 1-7 and 9. For example, the method 800 may be implemented at the laptop computing device 100 of FIG. 1 or the tablet computing device 200 of FIG. 2.

It will be appreciated that the following description of method 800 is provided by way of example and is not meant to be limiting. Therefore, it is to be understood that method 800 may include additional and/or alternative steps relative to those illustrated in FIG. 8. Further, it is to be understood that the steps of method 800 may be performed in any suitable order. Further still, it is to be understood that one or more steps may be omitted from method 800 without departing from the scope of this disclosure. It will also be appreciated that method 800 also may be performed in other contexts using other suitable components.

At 802, the method 800 includes determining, using an airflow detector located within the chassis, a velocity of the airflow. For example, the airflow detector 106 of FIG. 1 may be used to determine the velocity of the airflow within at least a portion of the base chassis 102 of the laptop 100, or the airflow detector 212 of FIG. 2 may be used to determine the velocity of the airflow within at least a portion of the chassis 208 of the tablet 200.

At 804, determining the velocity of the airflow may comprise determining the velocity of the airflow at an exhaust opening in a housing of the cooling fan. At 806, determining the velocity of the airflow may comprise determining the velocity of the airflow at a location between an intake opening in a housing of the cooling fan and an exhaust opening in the housing. At 808, determining the velocity of the airflow may comprise using a hot wire anemometer to determine the velocity of the airflow.

At 810, the method 800 includes determining, using a cover closure sensor, that the cover is closed over the chassis. For example, the cover closure sensor 110 of FIG. 1 may be used to determine that the display chassis 104 is closed, or the cover closure sensor 216 of FIG. 2 may be used to determine that the cover 202 is closed.

At 812, the method 800 includes determining, using a thermal sensor located within the chassis, a temperature of the computing device. For example, the thermal sensor 108 of FIG. 1 may be used to determine a temperature of the laptop computing device 100, or the thermal sensor 214 may be used to determine a temperature of the tablet computing device 200.

At 814, the method 800 includes, at least on condition of (1) determining that the velocity of the airflow is less than or equal to a threshold velocity, (2) determining that the cover is closed, and (3) determining that the temperature of the computing device is greater than or equal to a threshold temperature, performing the cooling action. As introduced above, at 816, performing the cooling action may comprise throttling performance of the computing device, placing the computing device into a standby mode or a hibernate mode, or shutting down the computing device. In this manner, the temperature of the computing device can be regulated in a highly precise and accurate manner.

In some embodiments, the methods and processes described herein may be tied to a computing system of one or more computing devices. In particular, such methods and processes may be implemented as a computer-application program or service, an application-programming interface (API), a library, and/or other computer-program product.

FIG. 9 schematically shows a non-limiting embodiment of a computing system 900 that can enact one or more of the methods and processes described above. Computing system 900 is shown in simplified form. Computing system 900 may take the form of one or more other personal computers, server computers, tablet computers, home-entertainment computers, network computing devices, gaming devices, mobile computing devices, mobile communication devices (e.g., smart phone), and/or other computing devices. In the above examples, the laptop computing device 100 and the tablet computing device 200 may comprise computing system 900 or one or more aspects of computing system 900.

Computing system 900 includes a logic processor 904, volatile memory 908, and a non-volatile storage device 912. Computing system 900 may optionally include a display subsystem 916, input subsystem 920, communication subsystem 924, and/or other components not shown in FIG. 9.

Logic processor 904 includes one or more physical devices configured to execute instructions. For example, the logic processor may be configured to execute instructions that are part of one or more applications, services, programs, routines, libraries, objects, components, data structures, or other logical constructs. Such instructions may be implemented to perform a task, implement a data type, transform the state of one or more components, achieve a technical effect, or otherwise arrive at a desired result.

The logic processor 904 may include one or more physical processors (hardware) configured to execute software instructions. Additionally or alternatively, the logic processor may include one or more hardware logic circuits or firmware devices configured to execute hardware-implemented logic or firmware instructions. Processors of the logic processor 904 may be single-core or multi-core, and the instructions executed thereon may be configured for sequential, parallel, and/or distributed processing. Individual components of the logic processor optionally may be distributed among two or more separate devices, which may be remotely located and/or configured for coordinated processing. Aspects of the logic processor may be virtualized and executed by remotely accessible, networked computing devices configured in a cloud-computing configuration. In such a case, these virtualized aspects are run on different physical logic processors of various different machines, it will be understood.

Non-volatile storage device 912 includes one or more physical devices configured to hold instructions executable by the logic processors to implement the methods and processes described herein. When such methods and processes are implemented, the state of non-volatile storage device 912 may be transformed—e.g., to hold different data.

Non-volatile storage device 912 may include physical devices that are removable and/or built-in. Non-volatile storage device 912 may include optical memory (e.g., CD, DVD, HD-DVD, Blu-Ray Disc, etc.), semiconductor memory (e.g., ROM, EPROM, EEPROM, FLASH memory, etc.), and/or magnetic memory (e.g., hard-disk drive, floppy-disk drive, tape drive, MRAM, etc.), or other mass storage device technology. Non-volatile storage device 912 may include nonvolatile, dynamic, static, read/write, read-only, sequential-access, location-addressable, file-addressable, and/or content-addressable devices. It will be appreciated that non-volatile storage device 912 is configured to hold instructions even when power is cut to the non-volatile storage device 912.

Volatile memory 908 may include physical devices that include random access memory. Volatile memory 908 is typically utilized by logic processor 904 to temporarily store information during processing of software instructions. It will be appreciated that volatile memory 908 typically does not continue to store instructions when power is cut to the volatile memory 908.

Aspects of logic processor 904, volatile memory 908, and non-volatile storage device 912 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

When included, display subsystem 916 may be used to present a visual representation of data held by non-volatile storage device 912. As the herein described methods and processes change the data held by the non-volatile storage device, and thus transform the state of the non-volatile storage device, the state of display subsystem 916 may likewise be transformed to visually represent changes in the underlying data. Display subsystem 916 may include one or more display devices utilizing virtually any type of technology. Such display devices may be combined with logic processor 904, volatile memory 908, and/or non-volatile storage device 912 in a shared enclosure, or such display devices may be peripheral display devices.

When included, input subsystem 920 may comprise or interface with one or more user-input devices such as a stylus, touchpad, keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity; and/or any other suitable sensor.

When included, communication subsystem 924 may be configured to communicatively couple various computing devices described herein with each other, and with other devices. Communication subsystem 924 may include wired and/or wireless communication devices compatible with one or more different communication protocols. As non-limiting examples, the communication subsystem may be configured for communication via a wireless telephone network, or a wired or wireless local- or wide-area network, such as a HDMI over Wi-Fi connection. In some embodiments, the communication subsystem may allow computing system 900 to send and/or receive messages to and/or from other devices via a network such as the Internet.

The following paragraphs provide additional support for the claims of the subject application. One aspect provides a computing device, comprising: a cover; a chassis; a cover closure sensor configured to indicate whether the cover is closed over the chassis; a cooling fan inside the chassis, the cooling fan configured to generate an airflow within at least a portion of the chassis; an airflow detector located within the chassis; a thermal sensor located within the chassis; a processor; and a memory storing instructions executable by the processor to detect a thermal trip condition using at least signals from the airflow detector, the thermal sensor, and the cover closure sensor, the instructions executable to: determine, using the airflow detector, a velocity of the airflow; determine, using the cover closure sensor, that the cover is closed; determine, using the thermal sensor, a temperature of the computing device; and at least on condition of (1) determining that the velocity of the airflow is less than or equal to a threshold velocity, (2) determining that the cover is closed, and (3) determining that the temperature of the computing device is greater than or equal to a threshold temperature, perform a cooling action.

The computing device may additionally or alternatively include, wherein the cooling fan comprises a housing and an exhaust opening in the housing, and wherein the airflow detector is located within the exhaust opening. The airflow detector may be additionally or alternatively spaced at least 0.5 mm from a side wall of the housing. The computing device may additionally or alternatively include, wherein the cooling fan comprises a housing and an exhaust opening in the housing, wherein the airflow detector is located between an intake opening in the housing and the exhaust opening in the housing.

The computing device may additionally or alternatively include, wherein the airflow detector comprises a hot wire anemometer. The computing device may additionally or alternatively include, wherein the airflow detector is suspended between two support beams. The cooling action may additionally or alternatively include throttling performance of the computing device, placing the computing device into a standby mode or a hibernate mode, or shutting down the computing device.

The thermal sensor may additionally or alternatively include a virtual thermal sensor that outputs a temperature value for a location on or inside the computing device based upon one or more physical sensors at one or more other locations on or inside the computing device. The threshold velocity may be additionally or alternatively in the range of 0 meters/second to 0.02 meters/second. The threshold temperature may be additionally or alternatively in the range of 34° C. to 62° C.

Another aspect provides, at a computing device comprising a cover, a chassis, and a cooling fan configured to generate an airflow within at least a portion of the chassis, a method for performing a cooling action, the method comprising: determining, using an airflow detector located within the chassis, a velocity of the airflow; determining, using a cover closure sensor, that the cover is closed over the chassis; determining, using a thermal sensor located within the chassis, a temperature of the computing device; and at least on condition of (1) determining that the velocity of the airflow is less than or equal to a threshold velocity, (2) determining that the cover is closed, and (3) determining that the temperature of the computing device is greater than or equal to a threshold temperature, performing the cooling action.

Determining the velocity of the airflow may additionally or alternatively include determining the velocity of the airflow at an exhaust opening in a housing of the cooling fan. Determining the velocity of the airflow may additionally or alternatively include determining the velocity of the airflow at a location between an intake opening in a housing of the cooling fan and an exhaust opening in the housing. Determining the velocity of the airflow may additionally or alternatively include using a hot wire anemometer to determine the velocity of the airflow. Performing the cooling action may additionally or alternatively include throttling performance of the computing device, placing the computing device into a standby mode or a hibernate mode, or shutting down the computing device.

Another aspect provides a laptop computing device, comprising: a display chassis; a base chassis rotatably coupled to the display chassis; a display closure sensor configured to indicate whether the display chassis is closed over the base chassis; a cooling fan inside the base chassis, the cooling fan configured to generate an airflow within at least a portion of the base chassis; an airflow detector located within the base chassis; a thermal sensor located within the base chassis; a processor; and a memory storing instructions executable by the processor to detect a thermal trip condition using at least signals from the airflow detector, the thermal sensor, and the display closure sensor, the instructions executable to: determine, using the airflow detector, a velocity of the airflow; determine, using the display closure sensor, that the display chassis is closed; determine, using the thermal sensor, a temperature of the laptop computing device; and at least on condition of (1) determining that the velocity of the airflow is less than or equal to a threshold velocity, (2) determining that the display chassis is closed, and (3) determining that the temperature of the laptop computing device is greater than or equal to a threshold temperature, perform a cooling action.

The laptop computing device may additionally or alternatively include, wherein the cooling fan comprises a housing and an exhaust opening in the housing, and wherein the airflow detector is located within the exhaust opening. The laptop computing device may additionally or alternatively include, wherein the cooling fan comprises a housing and an exhaust opening in the housing, wherein the airflow detector is located between an intake opening in the housing and the exhaust opening in the housing. The airflow detector may additionally or alternatively include a hot wire anemometer. The cooling action may additionally or alternatively include throttling performance of the computing device, placing the computing device into a standby mode or a hibernate mode, or shutting down the computing device.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A computing device, comprising:
a cover;
a chassis;
a cover closure sensor configured to indicate whether the cover is closed over the chassis;
a cooling fan inside the chassis, the cooling fan configured to generate an airflow within at least a portion of the chassis, wherein the cooling fan comprises a housing having a side wall and an exhaust opening;
an airflow detector located within the chassis, wherein the airflow detector is located within the exhaust opening and wherein the airflow detector is spaced at least 0.5 mm from the side wall of the housing;
a thermal sensor located within the chassis;
a processor; and
a memory storing instructions executable by the processor to detect a thermal trip condition using at least signals from the airflow detector, the thermal sensor, and the cover closure sensor, the instructions executable to:
determine, using the airflow detector, a velocity of the airflow;
determine, using the cover closure sensor, that the cover is closed;
determine, using the thermal sensor, a temperature of the computing device; and
at least on condition of (1) determining that the velocity of the airflow is less than or equal to a threshold velocity, (2) determining that the cover is closed, and (3) determining that the temperature of the computing device is greater than or equal to a threshold temperature, perform a cooling action.

2. The computing device of claim 1, wherein the airflow detector comprises a hot wire anemometer.

3. The computing device of claim 1, wherein the airflow detector is suspended between two support beams.

4. The computing device of claim 1, wherein the cooling action comprises throttling performance of the computing device, placing the computing device into a standby mode or a hibernate mode, or shutting down the computing device.

5. The computing device of claim 1, wherein the thermal sensor comprises a virtual thermal sensor that outputs a temperature value for a location on or inside the computing device based upon one or more physical sensors at one or more other locations on or inside the computing device.

6. The computing device of claim 1, wherein the threshold velocity is in the range of 0 meters/second to 0.02 meters/second.

7. The computing device of claim 1, wherein the threshold temperature is in the range of 34° C. to 62° C.

8. At a computing device comprising a cover, a chassis, and a cooling fan configured to generate an airflow within at least a portion of the chassis, the cooling fan comprising a housing having a side wall and an exhaust opening, a method for performing a cooling action, the method comprising:
determining, using an airflow detector located within the chassis, a velocity of the airflow at the exhaust opening of the housing, wherein the airflow detector is spaced at least 0.5 mm from the side wall of the housing;
determining, using a cover closure sensor, that the cover is closed over the chassis;
determining, using a thermal sensor located within the chassis, a temperature of the computing device; and
at least on condition of (1) determining that the velocity of the airflow is less than or equal to a threshold velocity, (2) determining that the cover is closed, and (3) determining that the temperature of the computing device is greater than or equal to a threshold temperature, performing the cooling action.

9. The method of claim 8, wherein determining the velocity of the airflow comprises using a hot wire anemometer to determine the velocity of the airflow.

10. The method of claim 8, wherein performing the cooling action comprises throttling performance of the computing device, placing the computing device into a standby mode or a hibernate mode, or shutting down the computing device.

11. A laptop computing device, comprising:
a display chassis;
a base chassis rotatably coupled to the display chassis;
a display closure sensor configured to indicate whether the display chassis is closed over the base chassis;
a cooling fan inside the base chassis, the cooling fan configured to generate an airflow within at least a portion of the base chassis, the cooling fan comprising a housing having a side wall and an exhaust opening;
an airflow detector located within the base chassis, wherein the airflow detector is located within the exhaust opening and wherein the airflow detector is spaced at least 0.5 mm from the side wall of the housing;
a thermal sensor located within the base chassis;
a processor; and
a memory storing instructions executable by the processor to detect a thermal trip condition using at least signals from the airflow detector, the thermal sensor, and the display closure sensor, the instructions executable to:
determine, using the airflow detector, a velocity of the airflow;
determine, using the display closure sensor, that the display chassis is closed;
determine, using the thermal sensor, a temperature of the laptop computing device; and
at least on condition of (1) determining that the velocity of the airflow is less than or equal to a threshold velocity, (2) determining that the display chassis is closed, and (3) determining that the temperature of the laptop computing device is greater than or equal to a threshold temperature, perform a cooling action.

12. The laptop computing device of claim 11, wherein the airflow detector comprises a hot wire anemometer.

13. The laptop computing device of claim 11, wherein the cooling action comprises throttling performance of the computing device, placing the computing device into a standby mode or a hibernate mode, or shutting down the computing device.

14. The method of claim 8, wherein the airflow detector is suspended between two support beams.

15. The method of claim 8, wherein the thermal sensor comprises a virtual thermal sensor that outputs a temperature value for a location on or inside the computing device based upon one or more physical sensors at one or more other locations on or inside the computing device.

16. The method of claim 8, wherein the threshold velocity is in the range of 0 meters/second to 0.02 meters/second.

17. The method of claim 8, wherein the threshold temperature is in the range of 34° C. to 62° C.

18. The laptop computing device of claim 11, wherein the airflow detector is suspended between two support beams.

19. The laptop computing device of claim 11, wherein the thermal sensor comprises a virtual thermal sensor that outputs a temperature value for a location on or inside the computing device based upon one or more physical sensors at one or more other locations on or inside the computing device.

20. The laptop computing device of claim 11, wherein the threshold velocity is in the range of 0 meters/second to 0.02 meters/second.
